(19) United States
(12) Patent Application Publication
(10) Pub. No.: US 2016/0144536 A1
(43) Pub. Date: May 26, 2016

(54) Casting Method For Producing A Protective Sheath Around A Surge Arrestor And A Casting Mold Therefor

(71) Applicant: SIEMENS AKTIENGESELLSCHAFT, München (DE)

(72) Inventor: BERND KRUSKA, BERLIN (DE)

(73) Assignee: Siemens Aktiengesellschaft, Munchen (DE)

(21) Appl. No.: 14/904,466

(22) PCT Filed: Jul. 8, 2014
(86) PCT No.: PCT/EP2014/064575

§ 371 Date: Jan. 12, 2016

(30) Foreign Application Priority Data
Jul. 12, 2013 (DE) 10 2013 213 688.9

(51) Int. Cl. B29C 39/10; B29C 39/02

(52) U.S. Cl. CPC B29C 39/10; B29C 39/025; B29K 2083/00

(57) ABSTRACT

A casting method producing a protective sheath around a surge arrester having a cylindrical discharge element between end fittings and retaining rods clamped into the fittings and surrounding the discharge element, includes placing the arrester into a first mold, pouring casting compound around the arrester to mold on a supporting part inwardly around the discharge element and outwardly around the rods, curing the compound to fix the rods and discharge element, removing the arrester with the supporting part from the first mold and placing it into a second mold, pouring compound around the arrester with supporting part forming a shield part shaped as protective sheath and curing the compound. A first casting mold has first recesses around rods of an inserted arrester. The rods and discharge element are fixed by a supporting part molded on during the first casting and cannot be bent or displaced during subsequent casting.

The invention relates to a casting method for producing a protective sheath around a surge arrester for use in high and medium voltage applications in accordance with the preamble of claim 1, and also a casting mold for implementing the casting method.

Surge arresters that are provided for the purpose of being used outdoors are surrounded by a protective sheath of by way of example silicon. A protective sheath of this type can also be necessary for example so as to protect said surge arresters against contamination when they are used in buildings. This protective sheath is used on the one hand for the purpose of protecting the surge arrester against the effects of weather, and on the other hand so as to electrically insulate said surge arrester. The protective sheath frequently comprises shields so as to provide a sufficient creepage distance. In terms of the invention, the surge arresters are surge arresters that are of the type that are suitable for high voltage and medium voltage applications.

Protective sheaths of this type are frequently attached to the surge arrester in an injection molding method. The shape of the protective sheath is provided by means of a casting mold, in particular an injection mold. Known casting molds comprise two half molds that can be assembled to form a matrix that forms the negative of the outer mold. The surge arrester is placed into one of the half molds and thus forms a core of the casting mold. The two half molds are then assembled together. The matrix and the core together form a hollow mold that corresponds to the negative mold of the protective sheath that is to be cast. When the core is in position and the half molds assembled together, the hollow mold is then injected at a high pressure with a casting compound such as silicone. Depending upon the viscosity of the silicone that is used, the pressure can amount to some Megapascals (10 bar) up to more than 100 Megapascals (1000 bar).

The air that is displaced by means of the casting compound can escape through ventilation openings in the casting mold. Alternatively, the casting mold can be evacuated prior to injecting the casting compound. After curing or the polymerization of the casting compound, the half molds are separated from one another. The surge arrester is now securely surrounded by the protective sheath and can be removed from the casting mold. The casting mold is then cleaned and is available to use for a further casting process.

Surge arresters are frequently produced in a so-called cage design. In this case, an active part of a cage of tensile elements that is formed from a stack of varistor elements is surrounded by way of example by glass fiber reinforced synthetic material, said tensile elements being clamped in end fittings and they thus hold together the active part. A surge arrester of this type can be several meters long. As a result of the high pressure of the silicone during the casting process, it is possible for the active part to be bent out of shape from its axis or for the tensile elements to be displaced with respect to the active part or to be pushed apart. This can lead to the surge arrester not passing the required electrical and mechanical tests and to said surge arrester being regarded as a reject. Generally, it is not possible to rework said surge arrester.

Possibilities for increasing the stability of the surge arrester by means of additional components are known from the prior art.

WO 2012/062695 A1 accordingly describes an expandable sheath that is placed around the tensile elements and fixes said tensile elements with respect to one another.

DE 101 04 393 C1 and EP 0 280 189 A1 disclose supporting plates having cut-outs through which the tensile elements are guided and thus fixed in a plane perpendicular to the longitudinal axis of the surge arrester.

In U.S. Pat. No. 5,608,597 A1, a bandage of glass fiber reinforced synthetic material is wound around the tensile elements that are consequently fixed with respect to one another.

The higher outlay for assembly and material requirements is disadvantageous in the prior art.

The object of the present invention is to provide a casting method that renders possible a reliable casting without deforming the active part or the cage of tensile elements and does not require additional components that are to be assembled on the surge arrester. A further object is to provide a casting mold for this purpose.

The object relating to the casting method is achieved by virtue of the inventive means in accordance with claim 1.

For this purpose, a casting method for producing a protective sheath around a surge arrester is provided. The surge arrester comprises an active part having a cylindrical discharge element that is arranged between two end fittings. The discharge element is usually embodied from a stack of cylindrical varistor blocks. The end fittings are arranged on the ends of the stack. In order to ensure a good electrical contact between the varistor blocks, it is necessary to press the stack together in a mechanical manner. For this purpose, a cage of retaining rods is used to surround the discharge element, said retaining rods being clamped in the end fittings. The retaining rods are produced from an electrically insulating and mechanically tensile material such as glass fiber reinforced synthetic material. The retaining rods are securely braced with their ends in the end fittings, by way of example by means of being screwed, wedged or crimped.

In the case of the casting method in accordance with the invention, the surge arrester is initially placed into a first mold. The first mold is generally embodied from two half molds that can be assembled together. The surge arrester is placed into one of the half molds and the first mold is closed with the second half mold. The half molds are pressed together in a hydraulic, pneumatic or mechanical manner. Seals and sealing surfaces provide a good sealing arrangement of the first mold so that casting compound cannot escape. Ventilation openings can be arranged in the first mold in order to avoid air pockets in the casting compound. Alternatively or in addition thereto, the first mold can be evacuated. Casting compound is poured into the first mold during the first casting process or is injected at high pressure. As a consequence, a supporting part is molded on to the surge arrestor and the inside of said supporting part nestles cylindrically around the discharge element and the outside of said supporting part nestles in a fillet-shaped manner around each of the retaining rods. The casting compound is cured by way of example by means of supplying heat. In the case of silicone, the molecular chains of the casting compound link and form a solid but resilient body in which the retaining rods are fixed.

The supporting part thus forms an inner part of the protective sheath. The supporting part is thereby a hollow cylinder that surrounds the discharge element in a radial manner, said hollow cylinder having an inner diameter that corresponds to the outer diameter of the discharge element and having an outer diameter that corresponds to the center spacing of two opposite-lying retaining rods. After the casting compound has cured, the retaining rods are consequently fixed with respect to one another and with respect to the discharge element.

The surge arrester with the supporting part molded thereon is removed from the first mold and placed into a second mold as a core. The second mold is a mold similar to that already used in the prior art. Said second mold is a matrix for the outer shape of the protective sheath. The surge arrester with the supporting part molded thereon is cast with casting compound in a second casting process by means of pouring or injecting casting compound into the second mold, wherein a shield part is formed, said shield part comprising the outer shape of the protective sheath. The shield part is a hollow cylinder with shields molded on the outside. After the casting compound has cured, the protective sheath is completely finished, the surge arrester with its protective sheath can be removed from the second mold and is ready to use. It is advantageous in the casting method in accordance with the invention that the retaining rods and the discharge element are fixed by means of the supporting part during the second casting process for the shield part to prevent deformation inwards towards the discharge element and laterally towards the adjacent retaining rod and it is therefore no longer possible for said retaining rods to bend or displace as a result of the casting compound. During the first casting process for the supporting part, this is avoided since the first mold comprises a considerably smaller volume than the second mold and thereby less space for movement.

It is preferred that the casting compound is not entirely cured after casting the supporting part so that while casting the shield part, the casting compound can link the supporting part and the shield part to one another and said supporting part and shield part are thus fixedly connected to one another.

The object relating to the casting mold is achieved by virtue of the means of the invention in accordance with claim 2. Accordingly, a casting mold as a first mold for a casting method in accordance with the invention comprises first grooves for receiving the retaining rods of a surge arrester that is placed into said mold and said first grooves nestle around the retaining rods in a fillet-shaped manner. The fillet-shaped first grooves encompass the retaining rods on their outer side as viewed from the longitudinal axis of the surge arrester, preferably to less than half of their circumference. The region between the retaining rods and the discharge element remains free. This region is filled during the first casting process with casting compound. Said casting compound then surrounds the retaining rods on their inner side. As a consequence, after the casting compound has cured, it nestles in a fillet-shaped manner around the inner side of the retaining rods and fixes said retaining rods for the second casting process. The region between adjacent retaining rods is in part filled by means of the first mold and remains free with respect to the other part. The supporting part is molded on during the first casting process in the part that remains free. The retaining rods are already fixed in the first grooves during the first casting process for the supporting part by means of the fillet-shaped first grooves of the first mold and said retaining rods can thus not be displaced during the first casting process.

Usually, the first mold is assembled from two half molds. The joining surface of the two half molds extends along the longitudinal axis. The half molds can be assembled and separated in a direction perpendicular to the joining surface. The first grooves extend in the cross section essentially in the opening direction, which makes opening and closing the first mold easier.

In a preferred embodiment, the first mold comprises second grooves for receiving the retaining rods and the retaining rods lie on said second grooves in each case along a surface line. While the retaining rods lie flat with a part of their peripheral surface in the first grooves, they lie in the second grooves only with a surface line. The surface line lies on the outside on the retaining rods when viewed from the longitudinal axis. The retaining rods are thus supported from the outside. In the first casting process, the casting compound can then almost entirely surround the retaining rods in the region of the second grooves. Only the region of the surface line of the retaining rods remains free from casting compound. The supporting part thus almost entirely surrounds the retaining rods in the region of the second grooves. The second grooves surround the retaining rods in a U-shaped manner. The depth is measured in such a manner that the retaining rods are entirely received in their diameter and the width is measured in such a manner that the casting compound that is cured therein almost entirely surrounds the retaining rods. It is preferred that the width amounts to approximately twice the diameter of the retaining rods. As a consequence, the retaining rods are also fixed to prevent bending or deforming towards the exterior.

In addition, it is preferred that the first mold comprises multiple lugs that radially support the discharge element to prevent bending. The lugs extend radially towards the discharge element and support said discharge element on multiple sites that are distributed around the circumference of the discharge element. As a consequence, the discharge element is prevented from bending with respect to the longitudinal axis during the first casting process.

Furthermore, an advantageous embodiment of the invention provides that the lugs are arranged in each case between two second grooves. The lugs are thus formed by means of two adjacent arms of two adjacent u-shaped second grooves, which render possible a simple embodiment of the first form in the region of the second grooves.

In addition, it is preferred that the second grooves are arranged in a longitudinal direction in the center of the first mold and in each case first grooves connect thereto in the longitudinal direction at the two ends. The first mold is thus divided into three longitudinal sections that lie adjacent to one another along the longitudinal axis. In the center longitudinal section, the first mold comprises the second grooves and the lugs. Longitudinal sections that comprise the first grooves connect thereto in the longitudinal direction at the two ends. The first mold is consequently constructed in a symmetrical manner. The retaining rods are almost completely surrounded and thus fixed by the supporting part in their middle region, in other words in the region that is inclined to bend the most.

It is also preferred that the first mold can be assembled from modules, wherein at least two modules comprise first grooves and at least one module comprises second grooves. The first mold is assembled in the longitudinal direction from multiple modules. The modules are clamped or screwed with respect to one another. A module having second grooves is arranged in the center of the mold and modules having second grooves connect to said module at the two ends. The first mold can be extended or shortened by means of adding or removing modules having first grooves and can thus be adjusted to various lengths of surge arresters.

The invention is further explained hereinunder with reference to the drawings. In the drawings:

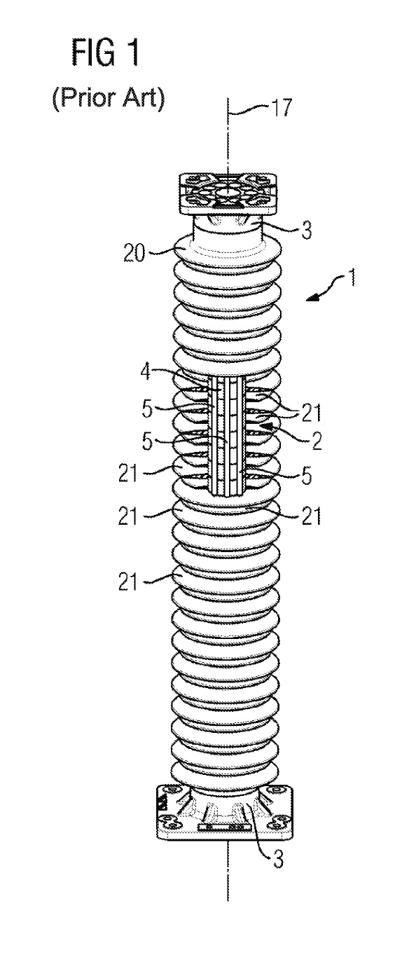

FIG. 1 illustrates a known surge arrester in a part sectional view,

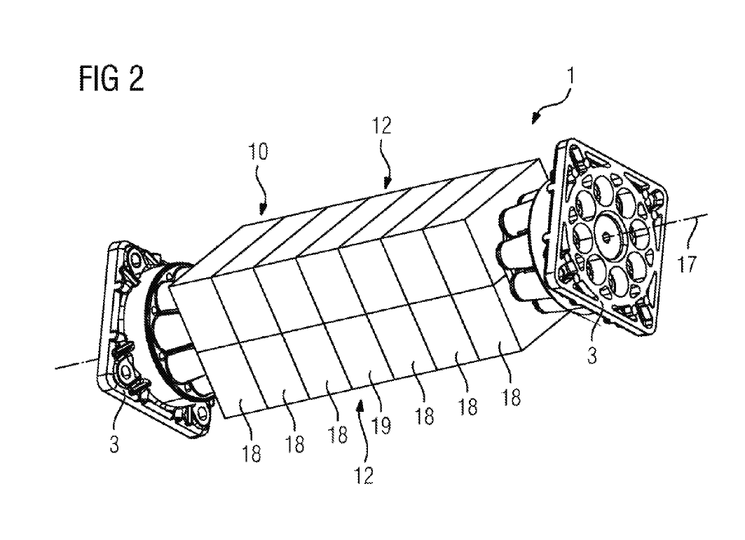

FIG. 2 illustrates a surge arrester that is placed into a first mold,

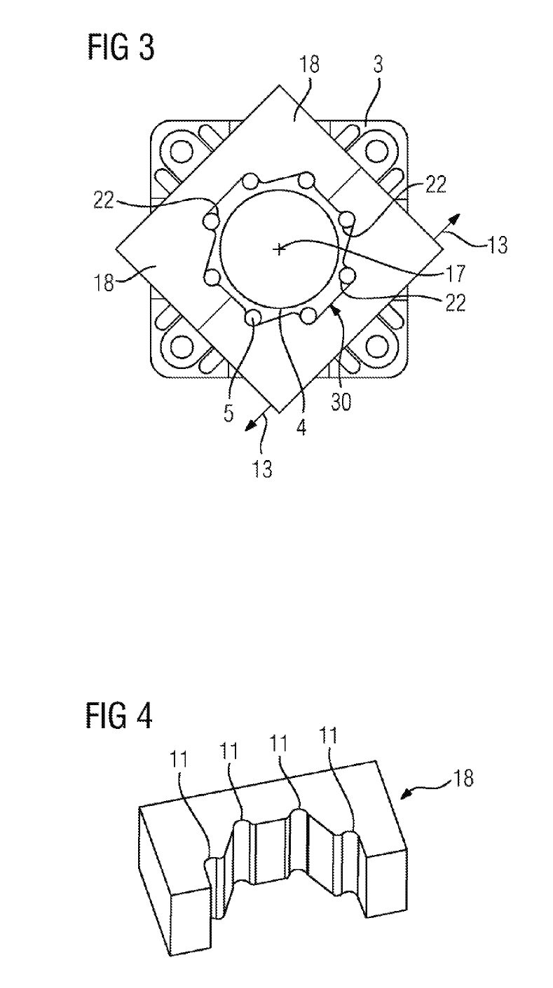

FIG. 3 illustrates a section through the first mold in the region of the first grooves,

FIG. 4 illustrates a part of the first mold having first grooves in a three-dimensional illustration,

FIG. 5 illustrates a section through the first mold in the region of the second grooves,

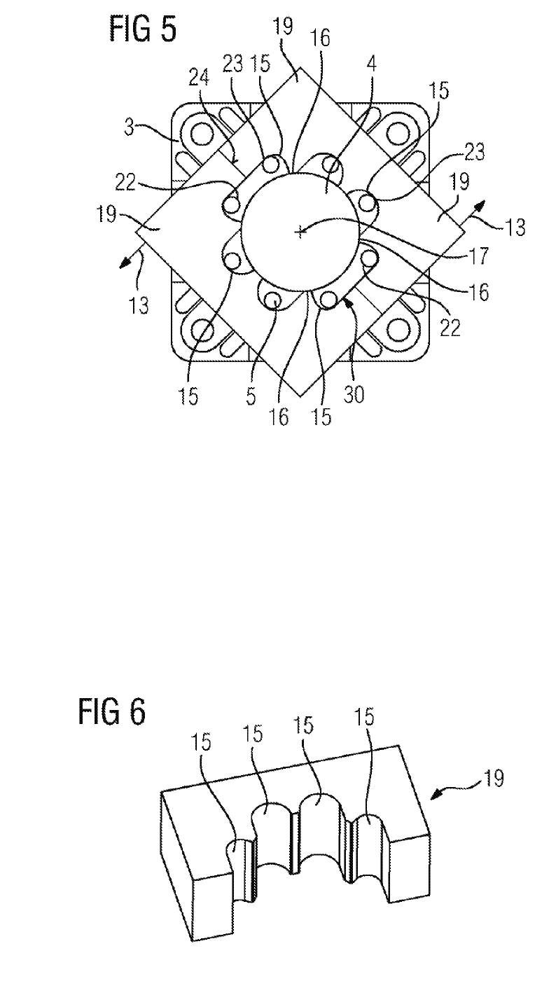

FIG. 6 illustrates a part of the first mold having second grooves in a three-dimensional illustration,

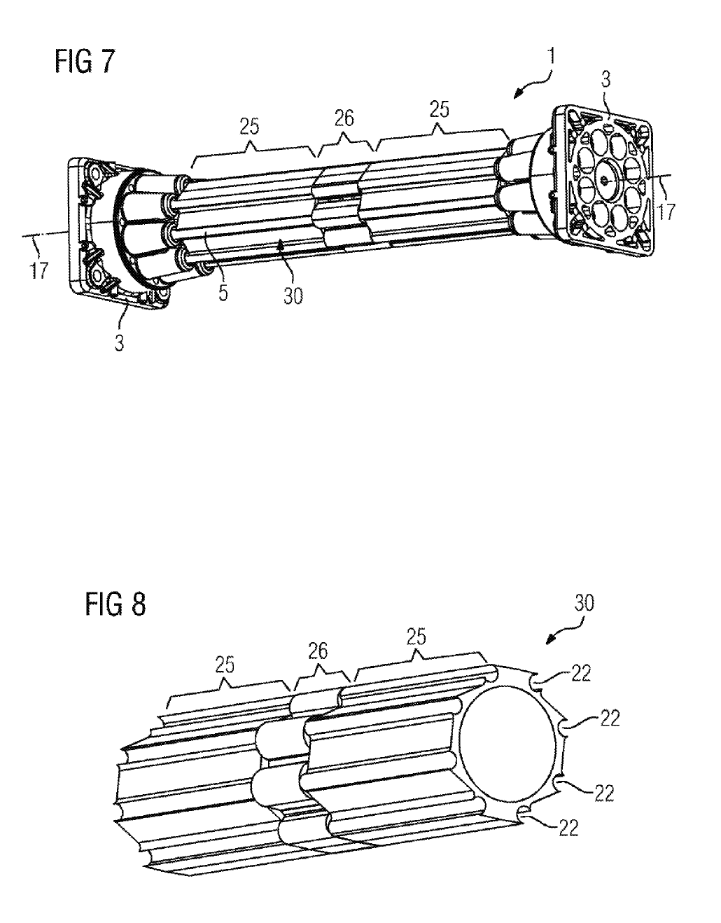

FIG. 7 illustrates a surge arrester with the supporting part molded on,

FIG. 8 illustrates a supporting part in a three-dimensional illustration,

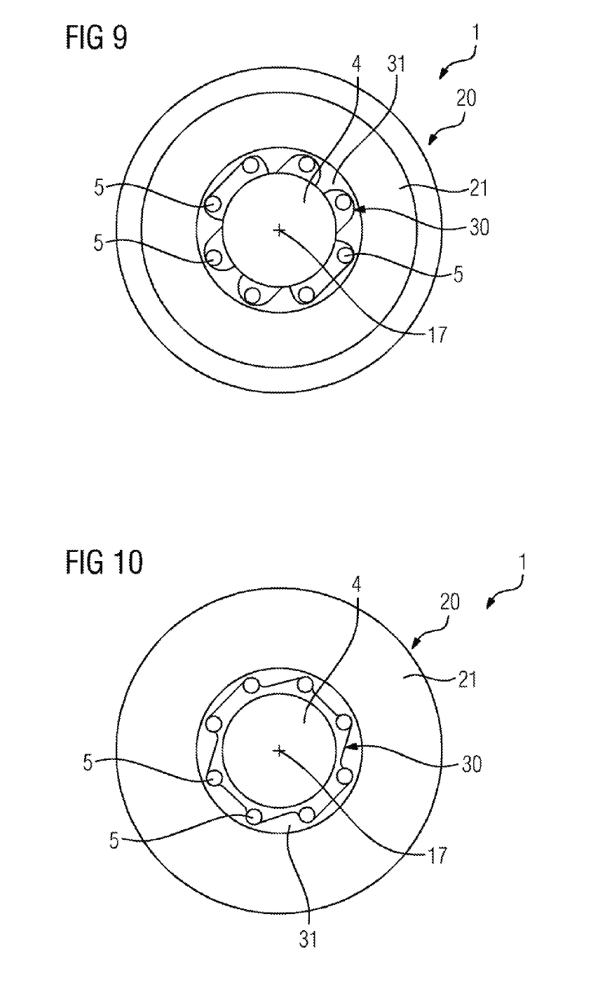

FIG. 9 illustrates a section through a surge arrester with the protective sheath molded on,

FIG. 10 illustrates a further section through a surge arrester with the protective sheath molded on.

Parts that correspond with one another are provided in all the figures with identical reference numerals.

FIG. 1 illustrates a known surge arrester 1 that is disclosed for example in DE 10 2011 078333. The surge arrester 1 comprises a cylindrical discharge element 4 that is embodied from cylindrical varistor blocks that are assembled to form a column. End fittings 3 are located in each case on the ends of this column and said end fittings are used to electrical connect the surge arrester 1. Retaining rods 5 form a cage around the discharge element 4 and are clamped in the end fittings 3 and thus hold the discharge element 4 together. The surge arrester 1 is provided with a protective sheath 20 so as to provide protection against the influences of weather. The protective sheath 20 surrounds the discharge element 4 entirely. Only parts of the end fittings 3 protrude beyond the protective sheath 20. The protective sheath 20 comprises shields 21 that are distributed in uniform spacings along the length of the protective sheath 20 in order to extend the creepage path between the end fittings 3. The shields 21 have two different sizes that are arranged in an alternating manner. The protective sheath 20 has the shape of a cylindrical body that surrounds the discharge element 4 and comprises end regions that lie adjacent thereto at the front end faces and form a sealing arrangement with the end fittings 3. The protective sheath 20 is frequently embodied from a polymer, by way of example from silicone, said polymer being applied in a casting method, frequently an injection molding method directly to the surge arrester 1. This is often referred to as direct casting. In the hitherto known casting method, the protective sheath 20 is produced entirely in one casting process. In the casting method in accordance with the invention, a supporting part 30 is initially molded onto the surge arrester 1 in a first casting process and subsequently a shielding part 31 is molded on in a second casting process. The supporting part 30 and shielding part 31 together form the protective sheath 20. Said protective sheath is further explained in the figures herein under.

FIG. 2 illustrates a surge arrester 1 that is placed into a first mold 10. The first mold 10 extends along the longitudinal axis 17 and surrounds the discharge element 4. The first mold 10 is assembled from two half molds 12. The surge arrester 1 is initially placed into one of the half molds 12. The first mold 10 is then closed using the second half mold 12. The contact surfaces of the half molds 12 are processed in such a manner that they close in a sealed manner when a corresponding contact pressure is applied. The first mold 10 is sealed by way of example on the ends with respect to the end fittings 3 so that casting compound cannot escape. The first mold 10 is assembled from multiple modules 18, 19. A module 19 that is arranged centrally comprises second grooves 15 that are not illustrated. Adjacent thereto at the two ends are arranged in each case three modules 18 having first grooves 11 that are not illustrated. The modules 18, 19 are assembled to form to a half mold 12 and by way of example are fixed by means of clamping or screwing. The first mold can be extended by means of using an additional module 18 in each half mold 12 in order to receive a longer surge arrester 1. Accordingly, it is possible to shorten the first mold 10 by means of removing modules 18.

FIG. 3 illustrates a section through a first mold 10 with a surge arrester 1 placed therein and a supporting part 30 that is already molded thereon in the region of a module 18, FIG. 4 illustrates a module 18 in a three-dimensional view. The first mold 10 could also be embodied in a hollow cylindrical manner in lieu of the first grooves 11 that are illustrated in this figure. The retaining rods 5 would then lie on the inner wall of the hollow cylinder. However, a preferred embodiment is illustrated in this case, wherein the first mold 10 comprises fillet-shaped first grooves 11 in the region of the module 18. The first grooves 11 are embodied as depressions that essentially extend in the opening direction 13. The first grooves 11 receive the retaining rods 5 and nestle on said retaining rods. The retaining rods 5 are thus secured in the case of a closed first mold 10 towards the exterior from the longitudinal axis and are also supported by means of the first mold 10 to prevent lateral deformation or bending. If casting compound is injected into the first mold 10, the retaining rods 5 are thus fixed by means of the first mold 10. As a consequence, the retaining rods 5 are prevented from bending or deforming. The casting compound that is injected into the first mold during the first casting process forms the supporting part 30 after curing. This supporting part 30 is a hollow cylindrical body that fills the space between discharge element 4 and first mold 10. The inside of said supporting part 30 nestles around the discharge element 4. The casting compound forms fillet-shaped depressions around the retaining rods on the outer side of the supporting part 30, said depressions nestling around the retaining rods 5. If the first mold 10 is opened in the opening direction 13, the retaining rods are thus fixed in the fillet-shaped depressions 22 of the supporting part.

FIG. 5 illustrates a section through a first mold 10 with a surge arrester 1 placed therein and a supporting part 30 that is already molded thereon in the region of a module 19, FIG. 6 illustrates a module 19 in a three-dimensional view. The first mold 10 comprises second grooves 15 in the region of the module 19 for receiving the retaining rods 5. The second grooves 15 are u-shaped depressions that receive the retaining rods 5 in their depth in their entire diameter. The retaining rods 5 lie in said second grooves with a surface line 23 and are supported by means of the first mold in the region of the module 19 with the second grooves 15. The width of the second grooves 15 corresponds approximately to double the diameter of a retaining rod 5. In the region of the contact surface 24 of the modules 19, adjacent second grooves 15 are connected to one another and form a u-shaped depression that receives two retaining rods 5. It is thus easy to open the first mold 10 by means of pulling apart the two half molds in the opening direction 13. In addition, in the region of the contact surface 24, the arms of the u-shaped depressions in each case of adjacent second grooves 15 form lugs 16 that extend as far as only in the region of the sleeve line 23 do the retaining rods 5 protrude beyond the casting compound that forms the supporting part 30.

FIG. 7 illustrates a surge arrester 1 with a supporting part 30 molded thereon, said surge arrester having been removed from the first mold; FIG. 8 illustrates a single supporting part 30. It is evident in a longitudinal section 26 that is arranged centrally with respect to the longitudinal axis 17 how the supporting part 30 is molded in the region of the module 19 with second grooves 15. The cured casting compound almost entirely surrounds the retaining rods 5. In the region of the longitudinal sections 25, the supporting part comprises fillet-shaped depressions 22 that receive and fix the retaining rods 5. For the subsequent second casting compound, the retaining rods 5 are fixed in such a manner that they can no longer be bent with respect to one another or with respect to the discharge element 4.

The surge arrester 1 with the supporting part 30 molded thereon is placed into a second mold for the second casting process, said second mold not being illustrated in this figure. A mold known per se can be used as the second mold, said known mold being hitherto used for the purpose of producing the protective sheath 20 in a single casting process. Hitherto, however, the surge arrester 1 alone would be used as the core. In the case of casting method in accordance with the invention, the surge arrester 1 with the supporting part 30 molded thereon is used as the core.

FIGS. 9 and 10 illustrate a section through a surge arrester 1 with a completed protective sheath 20. FIG. 9 illustrates a section in the region of the longitudinal section 26. The supporting part 30 that is molded on is evident around the discharge element 4 and also evident in the region radially outside thereof is the shield part 31 with a shield 21, in this case a shield 21 of the smaller of the two sizes, said shield part being molded on the supporting part in the second casting process, and behind said shield lies a shield 21 that is the larger of the two sizes. FIG. 10 illustrates a section in one of the longitudinal sections 25. The supporting part 30 that is molded on in this region and also the shield part 31 that is molded onto said supporting part radially outside thereof are also evident in this figure.

The shield part comprises a shield 21 that is the larger of the two sizes.

1-7. (canceled)

8. A casting method for producing a protective sheath around a surge arrester having a cylindrical discharge element disposed between two end fittings and a plurality of retaining rods clamped in the end fittings and surrounding the discharge element, the method comprising the following steps:
placing the surge arrester into a first mold;
pouring casting compound around the surge arrester so as to mold on a supporting part having an inside nestling cylindrically around the discharge element and an outside nestling in a fillet-shaped manner around each of the retaining rods;
curing the casting compound to fix the retaining rods relative to one another and relative to the discharge element;
removing the surge arrester with the supporting part molded thereon from the first mold and placing the surge arrester with the supporting part molded thereon into a second mold;
pouring casting compound around the surge arrester with the supporting part molded thereon to form a shield part having an external shape of the protective sheath; and
curing the casting compound.

9. A first mold for a casting method producing a protective sheath around a surge arrester having a cylindrical discharge element disposed between two end fittings and a plurality of retaining rods clamped in the end fittings and surrounding the discharge element, the first mold comprising:
first grooves for receiving the retaining rods of the surge arrester placed in the first mold, said grooves each nestling in a fillet-shaped manner around a respective one of the retaining rods.

10. The first mold according to claim 9, which further comprises second grooves for receiving the retaining rods, the retaining rods each lying on a respective one of said second grooves along a surface line.

11. The first mold according to claim 10, which further comprises a plurality of lugs radially supporting the discharge element to prevent bending.

12. The first mold according to claim 11, wherein said lugs are each disposed between a respective two of said second grooves.

13. The first mold according to claim 10, which further comprises a longitudinal direction of the first mold, a center of the first mold disposed along said longitudinal direction, said second grooves being disposed at said center of the first mold, and each of said first grooves being connected to a respective end of a respective one of said second grooves in the longitudinal direction.

14. The first mold according to claim 10, which further comprises modules being assembled to form the first mold, at least two of said modules having said first grooves and at least one of said modules having said second grooves.
